(19) United States
(12) Patent Application Publication
(10) Pub. No.: US 2021/0398117 A1
(43) Pub. Date: Dec. 23, 2021

(54) DATA VALIDATION APPLICATION PROGRAMMING INTERFACE

(71) Applicant: Wells Fargo Bank, N.A., San Francisco, CA (US)

(72) Inventors: Jonell Beth Van't Land, Richfield, MN (US); James Eric Quaal, Lakeville, MN (US); Luiz Fernando Flor da Silva, Pleasant Hill, CA (US); Mary K. Sangiacomo, San Francisco, CA (US); June Ann Wroblewski, Danville, CA (US)

(21) Appl. No.: 15/858,468

(22) Filed: Dec. 29, 2017

Related U.S. Application Data
(60) Provisional application No. 62/440,358, filed on Dec. 29, 2016.

(51) Int. Cl. G06Q 20/40; G06F 9/54; G06F 17/30

(52) U.S. Cl. CPC G06Q 20/40; G06F 17/30864; G06F 9/546

(57) ABSTRACT

A method may include receiving, from a requesting computing device, a structured data file, the structured data file including a set of defined data portions, wherein a first portion of the set of defined data portions includes: a first attribution identifier; a first account identifier; and a first amount; determining that the first attribution identifier is included in a set of permitted attribution identifiers; after the determining, querying a data store using the first attribution identifier and the first account identifier to retrieve a current amount associated with the first account identifier; calculating that the current amount is at least equal to the first amount; based on the calculating, formatting a first electronic response message that indicates a validated calculation for the first portion; and presenting the first electronic response message to the requesting computing device.

### CROSS-REFERENCE TO RELATED APPLICATION

This patent application claims the benefit of U.S. Provisional Patent Application No. 62/440,358, filed Dec. 29, 2016, entitled “DATA VALIDATION APPLICATION PROGRAMMING INTERFACE”, which is incorporated by reference herein in its entirety.

### TECHNICAL FIELD

Embodiments described herein generally relate to data processing and in particular, but without limitation, to an application data validation programming interface.

### BACKGROUND

Billions of electronic transactions occur every day and many are dependent on having valid and properly formatted data. If a transaction is improperly formatted or contains data that may not be verified, the transaction may fail. In some instances, transactions are batched together in a single data file because it is not practical or possible to process each transaction in real-time. Accordingly, some entities may not be aware of a failure of a transaction until the next day, assuming that the files are batched daily.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a schematic diagram of components of a system for data verification according to various examples;

FIG. 2 is a results user interface, according to various examples;

FIG. 3 illustrates a response package, according to various examples;

FIG. 4 illustrates a flowchart of operations for validating a structured data file, according to various examples;

FIG. 5 is a block diagram illustrating an example machine upon which any one or more of the techniques (e.g., methodologies) discussed herein may be performed, according to an example embodiment.

### DETAILED DESCRIPTION

Computing systems are responsible for processing billions of financial transactions per day. In some instances, technical limitations prevent companies from knowing if a transaction has failed until much later (e.g., a day) after the transaction was submitted for processing. Often, the transactions are submitted in accordance with one or more defined file formats. For example, the National Automated Clearly House Association (NACHA) defines the format for transactions that use the automated clearing house (ACH) electronic network. An ACH file may include thousands of entries that detail transfers of money between accounts based on routing and account numbers. A submitted ACH file may not be processed until the end of the day. Because of the non-real-time processing of ACH files, many companies find out the errors the next day. Accordingly, when errors occur (e.g., insufficient funds) it may take another day before a modified ACH file is generated and submitted. In other words, there is no technical mechanism to electronically determine if one or more transfers will fail for insufficient funds before submitting the ACH file.

Presented here are systems and methods that provide a technical solution to the problem described above. More specifically, this disclosure details an electronic service provided as an application programming interface (API) for technical validation of an ACH file with respect to fund verification—prior to the ACH file having been submitted for processing. And although the disclosure focuses on ACH files, the methods may be similarly applied to other data structures and financial transaction formats in which fund verification may be warranted before submitting a file for processing.

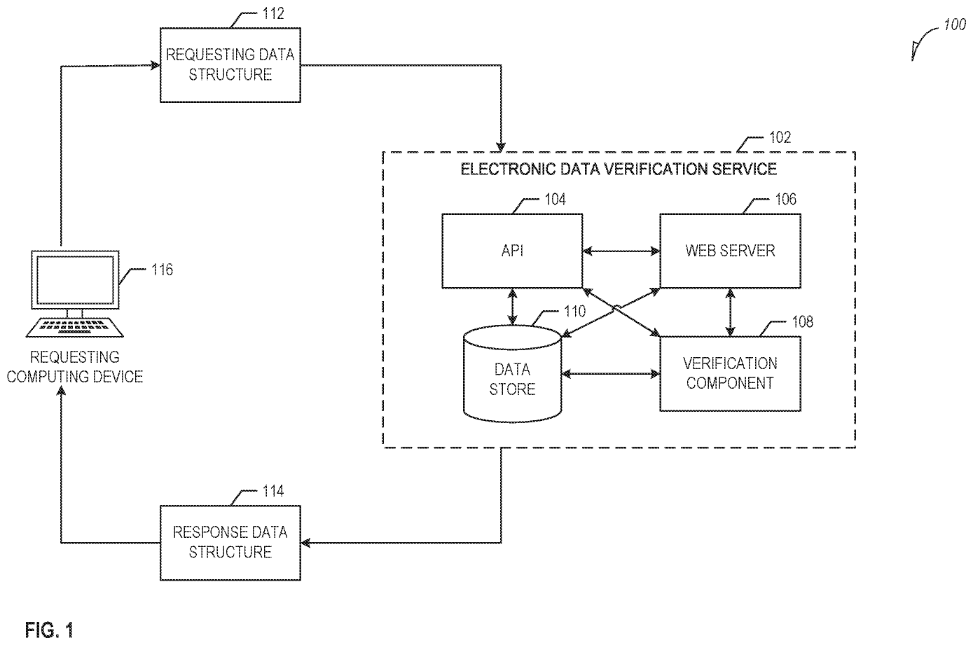

FIG. 1 illustrates a schematic diagram of components of a system for data verification according to various examples. The diagram illustrates electronic data verification service 102, which includes API 104, web server 106, verification component 108, and data store 110. The diagram further illustrates requesting data structure 112, response data structure 114, and requesting computing device 116.

An API may provide an interface for the exchange of a data between two computing systems or programs. In some instances, when the API is network accessible, the API may be considered a web API. Web server 106 may provide functions—such as by implementing a Representational state transfer API (RESTful API) via properly formatted hypertext transfer protocol (HTTP) messages—to process and respond to API calls according to API 104. An API request may come from external devices (e.g., requesting computing device 116) as well as from internal programs (e.g., web applications of electronic data verification service 102). For example, requesting computing device 116 may format an API call according to API 104 to send requesting data structure 112 to electronic data verification service 102 for processing. In response to the API call, electronic data verification service 102 may transmit a response message that contains response data structure 114.

In various examples, the servers and components illustrated in FIG. 1 may communicate via one or more networks. The network(s) may include one or more of local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network(s) may include a single local area network (LAN) or wide-area network (WAN), or combinations of LAN's or WAN's, such as the Internet.

Data used in electronic data verification service 102 may be organized and stored in a variety of manners. For convenience, the organized collection of data is described herein as data store 110. The specific storage layout and model used in data store 110 may take a number of forms—indeed, data store 110 may utilize multiple models. Data store 110 may be, but is not limited to, a relational database (e.g., SQL), non-relational database (NoSQL) a flat file database, object model, document details model, or a file system hierarchy. Data store 110 may store data on one or more storage devices (e.g., a hard disk, random access memory (RAM), etc.). The storage devices may be in standalone arrays, part of one or more servers, and may be located in one or more geographic areas. The storage devices may be part of different computing systems.

A database management system (DBMS) may be used to access the data stored within data store 110. The DBMS may offer options to search data store 110 using a query and then return data in the data store 110 that meets the criteria in the query. For example, a SQL query may be utilized to retrieve balance information for a given account number. The DBMS may operate on one or more of the components of electronic data verification service 102.

Furthermore, although API 104, web server 106, data store 110, and verification component 108 are illustrated being part of a single entity (electronic data verification service 102) different architectural arrangements may be used. For example, verification component 108 may query a data store that is not co-located with verification component 108. Similarly, web server 106 may be implemented as an array of computing servers that do not perform the functions of verification component 108.

In an example, electronic data verification service 102 is a service provided by a financial institution. One or more routing numbers may have been assigned to the financial institution. Furthermore, within data store 110, the financial institution may have account data (e.g., available funds) for a number of accounts. Accordingly, given a requested transfer amount, the financial institution may be able to calculate if there are sufficient funds for the transfer.

Requesting computing device 116 may be part of a payroll system. A company may use the payroll system to determine the amount of money needed to pay the company's employees based on information received from the company (e.g., number of hours worked, hourly rate, etc.). As part of this process, the payroll system may generate an ACH data file to initiate the transfer of money between financial accounts.

The payroll system may not know, however, if there are sufficient funds in the financial accounts to cover the transfer. In order to electronically verify the funds, requesting computing device 116 may transmit the AGI file (e.g., requesting data structure 112) to electronic data verification service 102. Electronic data verification service 102 may receive requesting data structure 112 via an API call or as part of a file upload provided by web server 106. Requesting data structure 112 may be encrypted and/or the API call may be made over a secured communication link (e.g., Secured Socket Layer).

In some instances, requesting computing device 116 may authenticate with electronic data verification service 102 before, or at the time of, submitting requesting data structure 112. Authentication may include providing credentials (e.g., token, username/password combination) to electronic data verification service 102. The credentials may be provided as part of the API call to electronic data verification service 102.

Verification component 108 may process requesting data structure 112 to determine if there are sufficient funds in originating accounts contained with the ACH file to cover a transfer. ACH files have a defined structure made up of five main records: (1) File Header Record; (2) one or more Batch Header Records: (3) one or more PPD Entry Detail Records; (4) one or more Batch Control Records; and (5) a file control record. Each of these records includes precise formatting requirements such as 94 characters per line and what data is to be placed at each character (e.g., character position 1 of a PPD entry is always a ‘6’). Among other information, the ACH file details routing and account numbers and amounts to be transferred from such accounts. For example, a batch control record indicates the total amount of credits and debits to an account for all associated PPD entry records.

Because of the defined format, verification component 108 may parse an ACH file and determine, for a given account, the total amount of money to be debited across the entire ACH file. Additionally, as electronic data verification service 102 has access to account data for a number of accounts, verification component 108 may calculate if there are sufficient funds for the defined debits. In some examples, verification component 108 may ignore transfer amounts in the ACH file that uses routing numbers not associated with the financial institution.

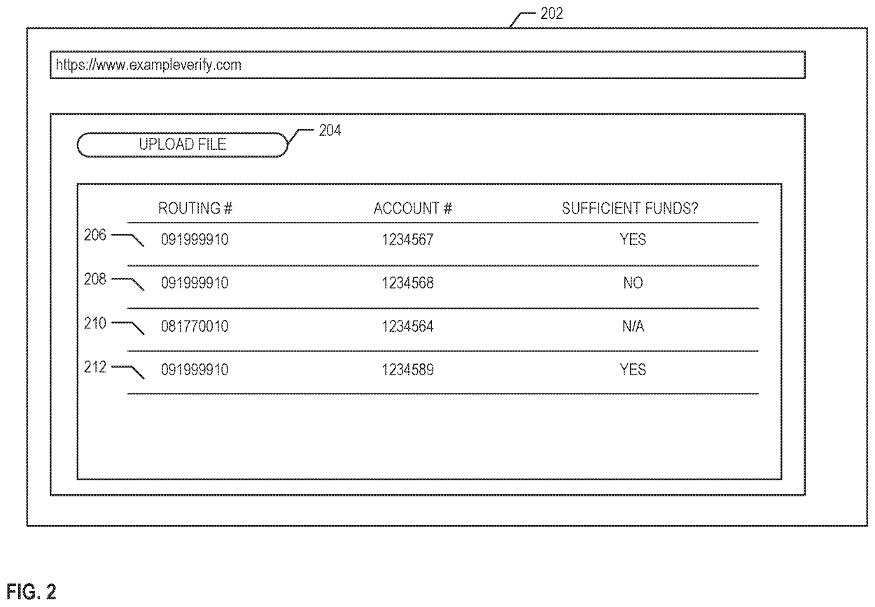

FIG. 2 is a results user interface, according to various examples. FIG. 2 illustrates web interface 202, upload UI element 204, and results 206-212. In an example, a user may navigate to web interface 202 using requesting computing device 116. The user may log in to web interface 202 using previously established credentials. Then, electronic data verification service 102 may receive an indication that the user has activated (e.g., clicked) upload UI element 204. Web interface 202 may then trigger a file upload interface (e.g., a file browser) that allows the user to select an ACH file for processing by verification component 108.

Verification component 108 may then parse the ACH file. Parsing may include generating a list of data entries such as [routing number, account number, amount] tuples. The information in the tuples may be ascertained by looking at the locations of such information as defined in the ACH file format, in an example. The list of entries may be iterated through to determine (1) if the routing number is part of the same financial institution associated with electronic data verification service 102 and (2) for the accounts that are associated with the financial institution, if there are sufficient funds to cover the indicated debit in the ACH file.

To determine if the routing number is associated with the financial institution, a query may be made to data store 110. Data store 110 may store a list of routing numbers for which electronic data verification service 102 may access account balance data. If a routing number is stored in data store 110, it may be considered valid.

Web server 106 may present the results to the requesting computing device 116 using an interface such as depicted in FIG. 2. For discussion purposes, consider that “091999910” is a valid routing number and “081770010” is invalid. Result 206 indicates that for account 1234567 the routing number is valid and there are sufficient funds to implement the ACH file. In contrast, result 208 indicates that account “1234568” has insufficient funds despite having a valid routing number. Result 210 indicates “N/A” under the “Sufficient Funds” column signifying the routing number was invalid. Finally, result 212 indicates that account “1234589” also has sufficient funds.

Verification may also include looking across different banks and financial institutions in an ACH file. For example, demand deposit accounts (DDA) in the ACH may be associated with different banks or financial institutions. In an example, an ACH file may be examined to review one DDA for the needed funds, but then debiting another DDA for the proceeds.

As one recalls, the processing of the ACH by verification component 108 occurs prior to the ACH file being processed as an actual transfer. In some examples, if verification component 108 determines all accounts in the ACH file have sufficient funds, electronic data verification service 102 may initiate the transfer. In other examples, the ACH file may be resubmitted by requesting computing device 116 (or a different computing device) to initiate the transfer.

Web interface 202 is an example of a layout for presenting the results. Other layouts and features may be used without departing from the scope of this disclosure. For example, a column indicating whether or not the routing number is valid may be used. Another column may indicate the amount of funds available in the account. A user interface element may be used to filter or sort the results (e.g., show only accounts with insufficient funds).

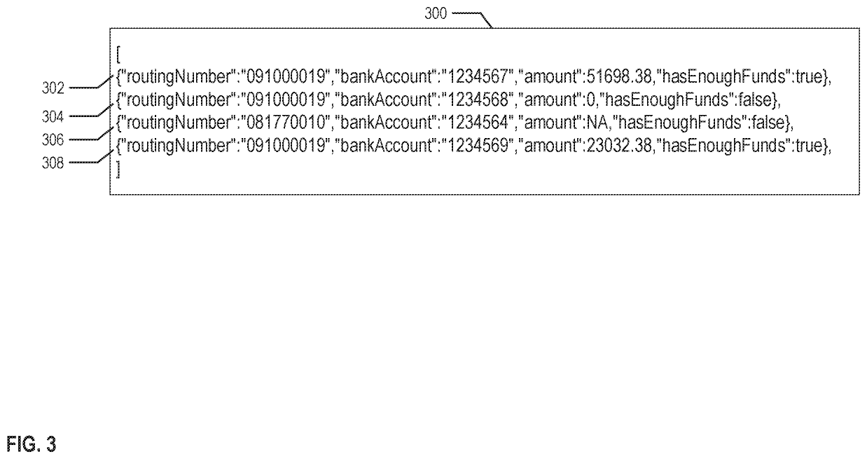

FIG. 3 illustrates a response package 300, according to various examples. Response package 300 may be generated by verification component 108 to transmit to requesting computing device 116 (or a different computing device if requested) after processing an ACH file. Response package 300 is illustrated according to JavaScript Object Notation (JSON), but other formats may be used. Response package 300 may include fields for routing number, banking account number, amounts, and sufficiency of funds. Some of these fields may be omitted in various examples (e.g., the amount). Response package 300 illustrates entries 302-308 and correspond to the displayed results 206-212.

Response package 300 may be used by electronic data verification service 102 to generate web interface 202 in various examples. For example, electronic data verification service 102 may internally invoke API 104 and receive a response package. The response package may be parsed and presented according to a defined layout (e.g., web interface 202). In other words, the same API call, and corresponding response package may be used by web server 106 as is used by requesting computing device 116. Thus, instead of the web server 106 needing its own ACH verification logic, API 104 may be used.

Additionally, having the verification logic contained in API 104 may allow further computing systems to submit ACH files for verification without a user. This may also permit those computing systems to use their own web servers to generate reports, web interfaces, etc., based on the response packages from API 104. Accordingly, “white label” ACH verification services may be provided by those computing systems.

API 104 may provide a function for verifying sufficiency of funds without an ACH file. For example, API 104 may respond to a request that submits a routing number, account number, and amount as parameters. A response package similar response package 300 may be transmitted back to a requesting device with the results.

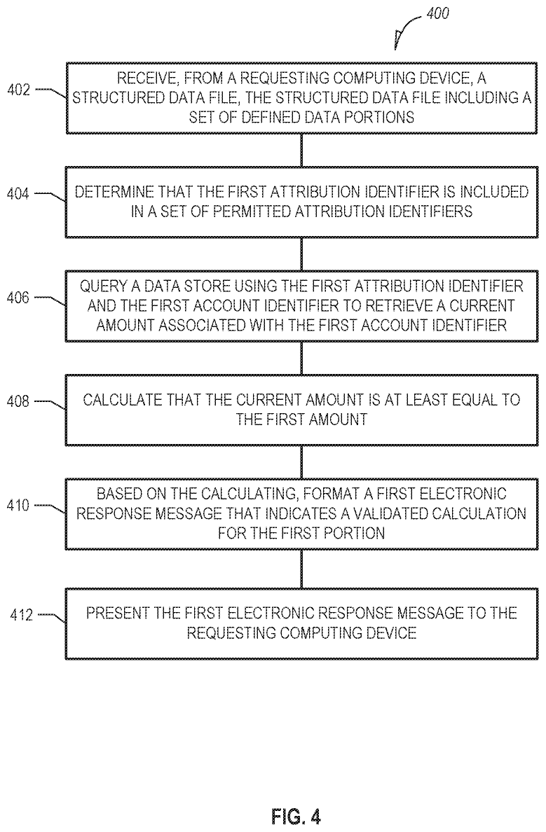

FIG. 4 illustrates a flowchart 400 of operations for validating a structured data file, according to various examples. The operations may be stored as program code on a storage device. A processor may load and execute the program code, which may configure the processor to perform the operations. Performance may include the processor controlling other devices such as network device, display devices, etc.

At operation 402, a structure data file may be received from a requesting computing device. The structured data file may be received at a computing system such as electronic data verification service 102. The structured data file may be received over an API. In an example, the structured data file is received in response to activation of an input portion of a user interface. The structured data file may include set of defined data portions. A first portion of the set of defined data portion may include, a first attribution identifier, a first account identifier, and a first amount. The attribution identifier may be a routing number of a financial institution and the account identifier may be an account number at the financial institution. The structured data file may be formatted as an ACH file.

At operation 404, it may be determined that the first attribution identifier is included in a set of permitted attribution identifiers. A permitted attribution identifier may be an identifier stored as associated with the financial institution. The set may include a set of routing numbers used by the financial institution. Determining whether the first attribution identifier is permitted may include querying a data storage device.

After the determining, a data store may be queried using the first attribution identifier and the first account identifier to retrieve a current amount associated with the first account identifier (operation 406). A calculation may determine that the current amount is at least equal to the first amount (operation 408).

At operation 410, a first electronic message may be formatted that indicates a validated calculation for the first portion. Formatting may include inserting the first attribution identifier, the first account identifier; the first amount, the current amount, and a result of the calculating into a data structure. The data structure may be formatted as a JSON message.

At operation 412 the first electronic response message may be presented to the requesting computing device. Presenting may include presenting a user interface that includes an output portion, the output portion identifying the first attribution identifier, the first account identifier, and data representing the first electronic response message. For example, a table layout may be presented on a webpage that includes the data in the response message. Presenting may also include transmitting the data structure to the requesting computing device.

A second portion of the defined data portions may include a second attribution identifier, a second account identifier, and a second amount. The operations may further include, based on determining that the second attribution identifier is not included in the set of permitted attribution identifiers, formatting a second electronic response message that indicates a non-validated calculation for the second portion. The first and second response messages may be transmitted as part of the same data structure, in an example. Indicating a non-valid calculation may include placing a “false” or other predetermined signifier as the value for a parameter in the data structure (e.g., “validated:0”).

### Example Computer System

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

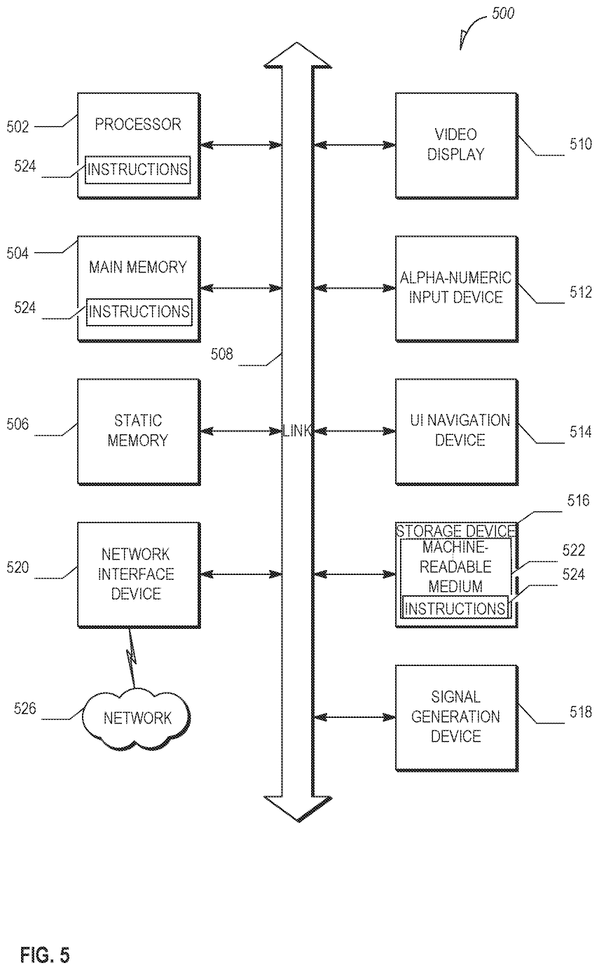

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method performed by a computing system executing instructions on at least one hardware processor, the method composing:
receiving, from a requesting computing device via a web application programming interface (API) of an electronic data verification service associated with a financial institution, an automated clearing house (ACH) file listing a plurality of transactions that have not yet been processed as actual transfers of funds, the requesting computing device having received the ACH file in response to user activation of an input portion of a user interface, the ACH file including, for each listed transaction, a routing number, an account identifier, and a debit amount;
for each of the listed transactions, determining whether the routing number is in a set of routing numbers associated with the financial institution;
for each unique pair of routing number and account identifier among the transactions listed in the ACH file where the routing number is in the set of routing numbers associated with the financial institution:
determining a total amount to be debited from the corresponding account across all transactions listed in the ACH file;
querying a data store using the routing number and the account identifier to retrieve a current balance in the corresponding account;
determining whether the current balance in the corresponding account is at least equal to the corresponding total amount of money to be debited from the corresponding account across all transactions listed in the ACH file; and
inserting, into an electronic response message, an indication of whether the current balance in the corresponding account is at least equal to the total amount of money to be debited from the corresponding account across all transactions listed in the ACH file;
for all other pairs of routing number and account identifier among the transactions listed in the ACH file, inserting into the electronic response message an indication that the corresponding routing number is not in the set of routing numbers associated with the financial institution; and
presenting the electronic response message on the requesting computing device, the presenting of the electronic response message comprising presenting an output portion of the user interface, the output portion identifying the unique pairs of routing number and account identifier among the transactions listed in the ACH file and the corresponding inserted indications.

2-5. (canceled)

6. The method of claim 1, further comprising inserting, into a data structure, for each unique pair of routing number and account identifier among the transactions listed in the ACH file, the routing number, the account identifier, the total amount to be debited from the corresponding account across all transactions listed in the AGI file, the corresponding current balance in the corresponding account, and the corresponding inserted indication.

7. The method of claim 6, wherein presenting the electronic response message on the requesting computing device includes transmitting the data structure to the requesting computing device in the electronic response message.

8. A non-transitory computer-readable medium having stored thereon instructions that, when executed by at least one hardware processor, cause the at least one hardware processor to perform operations comprising:
receiving, from a requesting computing device via a web application programming interface (API) of an electronic data verification service associated with a financial institution, an automated clearing house (ACH) file listing a plurality of transactions that have not yet been processed as actual transfers of funds, the requesting computing device having received the ACH file in response to user activation of an input portion of a user interface, the ACH file including, for each listed transaction, a routing number, an account identifier, and a debit amount;
for each of the listed transactions, determining whether the routing number is in a set of routing numbers associated with the financial institution;
for each unique pair of routing number and account identifier among the transactions listed in the ACH file where the routing number is in the set of routing numbers associated with the financial institution:
determining a total amount to be debited from the corresponding account across all transactions listed in the ACH file;
querying a data store using the routing number and the account identifier to retrieve a current balance in the corresponding account;
determining whether the current balance in the corresponding account is at least equal to the corresponding total amount of money to be debited from the corresponding account across all transactions listed in the ACH file; and
inserting, into an electronic response message, an indication of whether the current balance in the corresponding account is at least equal to the total amount of money to be debited from the corresponding account across all transactions listed in the ACH file;
for all other pairs of routing; number and account identifier among the transactions listed in the ACH file, inserting into the electronic response message an indication that the corresponding routing number is not in the set of routing numbers associated with the financial institution; and
presenting the electronic response message on the requesting computing device, the presenting of the electronic response message comprising presenting an output portion of the user interface, the output portion identifying the unique pairs of routing number and account identifier among the transactions listed in the ACH file and the corresponding inserted indications.

9-12. (canceled)

13. The non-transitory computer-readable medium of claim 8, the operations further comprising inserting, into a data structure, for each unique pair of routing number and account identifier among the transactions listed in the ACH file, the routing number, the account identifier, the total amount to be debited from the corresponding account across all transactions listed in the ACH file, the corresponding current balance in the corresponding account, and the corresponding inserted indication.

14. The non-transitory computer-readable medium of claim 13, wherein presenting the electronic response message on the requesting computing device includes transmitting the data structure to the requesting computing device in the electronic response message.

15. A system comprising;
at least one hardware processor; and
a storage device having stored thereon instructions that, when executed by the at least one hardware processor, cause the system to perform operations comprising:
receiving, from a requesting computing device via a web application programming interface (API) of an electronic data verification service associated with a financial institution, an automated clearing house (ACH) file listing a plurality of transactions that have not yet been processed as actual transfers of funds, the requesting computing device having received the ACH file in response to user activation of an input portion of a user interface, the ACH file including, for each listed transaction, a routing number, an account identifier, and a debit amount;
for each of the listed transactions, determining whether the routing number is in a set of routing numbers associated with the financial institution;
for each unique pair of routing number and account identifier among the transactions listed in the ACH file where the routing number is in the set of routing numbers associated with the financial institution;
determining a total amount to be debited from the correspondinu account across all transactions listed in the ACH file;
querying a data store using the routing number and the account identifier to retrieve a current balance in the corresponding account;
determining whether the current balance in the corresponding account is at least equal to the corresponding total amount of money to be debited from the corresponding account across all transactions listed in the ACH file; and
inserting, into an electronic response message, an indication of whether the current balance in the corresponding account is at least equal to the total amount of money to be debited from the corresponding account across all transactions listed in the ACH file;
for all other pairs of routing number and account identifier among the transactions listed in the ACH file, inserting into the electronic response message an indication that the corresponding routing number is not in the set of routing numbers associated with the financial institution; and
presenting the electronic response message on the requesting computing device, the presenting of the electronic response message comprising presenting an output portion of the user interface, the output portion identifying the unique pairs of routing number and account identifier among the transactions listed in the ACH file and the corresponding inserted indications.

16-19. (canceled)

20. The system of claim 15, the operations further comprising inserting, into a data structure, for each unique pair of routing number and account identifier among the transactions listed in the ACH file, the routing number, the account identifier, the total amount to be debited from the corresponding account across all transactions listed in the ACH file, the corresponding current balance in the corresponding account, and the corresponding inserted indication.

21. The system of claim 20, wherein presenting the electronic response message on the requesting computing device includes transmitting the data structure to the requesting computing device in the electronic response message.
